(19) United States
(12) Patent Application Publication
(10) Pub. No.: US 2020/0114436 A1
(43) Pub. Date: Apr. 16, 2020

(54) CNC SINK APERTURE CUTTING MACHINE AND METHOD

(71) Applicant: Mingye Song, Burr Ridge, IL (US)

(72) Inventor: Mingye Song, Burr Ridge, IL (US)

(21) Appl. No.: 16/598,942

(22) Filed: Oct. 10, 2019

Related U.S. Application Data
(60) Provisional application No. 62/743,927, filed on Oct. 10, 2018.

(51) Int. Cl. B23C 3/13; B28D 1/18

(52) U.S. Cl. CPC B23C 3/13; B23C 2226/75; B28D 1/18

(57) ABSTRACT

A device for cutting a sink opening in a countertop is described. The device includes a base for receiving and securing the countertop. It also includes a cutting assembly that has a rotating cutting tool and a servomotor for controlling a depth of the rotating cutting tool, multiple sets of guide rails attached to said base wherein said cutting assembly moves along said rails; a position controller which controls the position of said cutting assembly and the depth of the rotating cutting tool. The controller uses digital templates of sink openings to position the cutting assembly along the guide rails and sets the depth of the cutting tool.

### PRIORITY CLAIM

This utility patent application claims the benefits of U.S. Provisional Patent Application No. 62/743,927, filed on Oct. 10, 2018, currently pending, the entirety of which is incorporated herein by reference.

### BACKGROUND OF THE INVENTION

### 1. Field of the Invention

The field of the invention is a portable machine for cutting an arbitrary opening in a substrate, such as cutting an opening for a sink in a countertop.

### 2. Background of the Invention

In various embodiments, the invention provides a device for cutting precision apertures in substrates, and a method of cutting such precision apertures.

In one embodiment, the invention comprises a portable device which includes a cutting assembly that moves along several tracks. The cutting assembly includes a rotating cutting tool, whose depth of extension can be precision controlled. The device includes a controller which moves the cutting assembly to one or more positions and then extends the cutting tool to the desired depth. The invention also includes a method of cutting a precision opening in a short amount of time.

Prior art approaches for cutting sink openings include using a manual template and manually cutting the opening within a stone countertop. Such openings can take over an hour to complete. Nonetheless, the prevailing method in the industry is to use such a manual approach that uses hand-positioned tools and one or more templates. While automatic CNC machines exist which can cut openings in a number of ways, the machines are expensive, very large, and require professional training before an end user can successfully operate them for the first time.

State of the art systems often feature cutting bits which remain at a single position along the z-axis during cutting. This results in overwear along portions of the bit intermediate the bit's first cutting end and the bit's second end anchored by the chuck. Such overwear manifests itself as a countersunk region of the bit flanked by shoulders. These shoulders often bind with the workpiece during withdrawal of the bit, or during cutting, resulting in fracture of the bit, the workpiece, or both. Also, such overwear of the bit often results in uneven cuts to the workpiece.

A need exists in the art for a device that can cut openings in surfaces without the use of manual templates and without the use of expensive cutting devices. Furthermore, the ideal device and method should not require a professionally trained human operator.

### SUMMARY OF INVENTION

An object of the invention is to create a device and method for cutting an opening in a surface. An advantage of the invention is that it allows for cutting of an opening in a surface, such as a countertop.

Another object of the invention is to provide a cutting tool that is portable. A feature of the invention is that it includes a moveable base. An advantage of the invention is that the unit can be moved to different locations within a facility.

A further object of the invention is to eliminate the use of manual templates for cutting of apertures within a surface. A feature of the invention is that the controller which operates the components of the system uses digital templates as input to the system. An advantage of one embodiment is that the system can reuse templates indefinitely and is not limited to existing fixed templates for a given job.

Yet another object of the invention is to facilitate high-precision cutting of an opening. A feature of the invention is that in one embodiment the location of the cutting assembly can be controlled with a high degree of precision. An advantage of the system is that it can create openings of an arbitrary shape within a substrate such as a countertop.

Another object of the invention is to provide a device and method that can create openings in a limited amount of time. A feature of the invention is in one embodiment, the cutting assembly and cutting tool can begin work as soon as the countertop is loaded and will continue to cut the opening without stopping until the task is completed. A benefit of the invention is that the cutting of the opening can be completed as a single task performed in minimal time.

An additional object of the invention is to provide a cutting tool which minimizes waste. A feature of the invention is that the controller will begin cutting the opening only once the path of the cutting is known and confirmed to be correct. A benefit of the invention is that countertop cutting tasks are started only after providing user feedback.

A further object of the invention is to provide a cutting tool which is inexpensive. A feature of the system is that it includes a minimal number of components. A benefit of the system is that it can be serviced by the end user and assembled with fewer tools.

An additional object of the invention is to provide a system which minimizes usage of consumable materials. A feature of the invention is that the machine, in one embodiment, uses an incremental cutting bit combined with spiral tool feeding that doesn't wear off along the periphery of the bit but rather the wear occurs incrementally from the end. An advantage of the system is the elimination of premature wearing and replacement of the cutting tool. Another benefit is that the aforementioned feature causes any excessive wear to be easily detected without the need for periodic, scheduled inspection or disassembly, such that the end user will not over use the tool.

A further object of the invention is to provide a system which minimizes dust creation. A feature of the invention is that, in one embodiment, the system uses liquid dispersion and dust collection systems. A benefit of the invention is that dust created by the cutting system is minimized.

An additional object of the invention is to create a cutting tool which uses an easy to understand interface. A feature of the invention is that the cutting tool is specialized for cutting tasks. A benefit of the invention is that the tool does not include unnecessary options and can be used by any semi-skilled technician.

A further object of the invention is to provide an improved sink cutting device. A feature of the invention is that it doesn't use physical templates and instead uses digitally-stored and defined sink aperture shapes. Commercial sources provide popular digital templates, usually as DXF files, and free of charge. Once such source is Elkay Manufacturing Company, (Oak Brook, Ill.). An embodiment of the invention converts those commercially available templates into CNC machine code so that end users need not be professionally trained to create the machine code. Another feature is that the cutting processes, which include both cutting the opening to the correct shape and the correct depth, are automated, and not performed by hand, resulting in consistent aperture cuts. Another feature of the system is that it may optionally include automated polishing steps, including two phases of polishing tasks in one embodiment, further reducing the amount of variation between apertures. A benefit of the device is that the overall quality of the work is consistent and high.

A yet additional object of the invention is to provide a versatile sink opening cutting device. A feature of this invention, in one embodiment, is that the cutting system is attached to a base with three sides open for the end user to slide in the work piece such as a countertop surface. As the cutting device is not supported by the workpiece generally (and countertop specifically in most instances), there are no limitations on the size of the countertop to be altered using the system. Further, there is no limit on the sink opening size, specifically there is no practical sink opening that would be too small or too large for the device. A benefit of this system is that it can cut any sized opening and do so consistently

A device for cutting an opening in a workpiece (such as a sink opening in a countertop or vanity) is described, the device comprising: a base for removably receiving and securing the workpiece in a horizontally disposed, vertically disposed or angularly disposed position relative to horizontal level; a cutting assembly comprising a rotating cutting tool and a servomotor for controlling a depth of the rotating cutting tool; a second servomotor controlling the angle of the cut through the workpiece, a plurality of guide rails (perhaps multiple pairs of guide rails) attached to said base wherein said cutting assembly moves along said rails; a position controller which controls the position of said cutting assembly and the depth of the rotating cutting tool; wherein said controller uses digital templates of openings to position the cutting assembly along the guide rails.

The invention also provides a method for cutting an aperture in a workpiece, the method comprising supporting the workpiece; and using G-code to direct a cutting bit to form the aperture in the workpiece.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a perspective view of a cutting tool, in accordance with features of the present invention;

FIG. 2 depicts another perspective view of the cutting tool, with cable and water tube carrier shown, in accordance with features of the present invention;

FIG. 3A is a front view of the cutting tool with at least one cover removed, in accordance with features of the invention;

FIG. 3B is a detailed view of a coupling mechanism of the cutting device shown in FIG. 3A.

FIG. 4 depicts a detailed view of a component of one embodiment of the cutting tool, in accordance with features of the present invention;

FIG. 5A is a detailed view of initial alignment of the cutting tool to a coordinate origin marking on a workpiece, in accordance with features of the present invention;

FIG. 5B is a detailed view of the cutting tool tracing its programmed path along the surface of the workpiece, thereby simulating an actual cut out, in accordance with features of the present invention;

FIG. 5C is a detailed view of the cutting tool with the cutout of the workpiece removed;

FIG. 5D is a detail sequence of a pattern of cutting the workpiece, in accordance with features of the present invention;

FIG. 6 depicts a flowchart of use of embodiment cutting tool, in accordance with features of the present invention;

FIG. 7 depicts an electrical schematic of the cutting tool, in accordance with features of the present invention; and

FIG. 8 depicts a perspective view of a horizontally disposed cutting tool, in accordance with features of the invention; and

FIG. 9 depicts a front view of the cutting tool, in accordance with features of the present invention.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

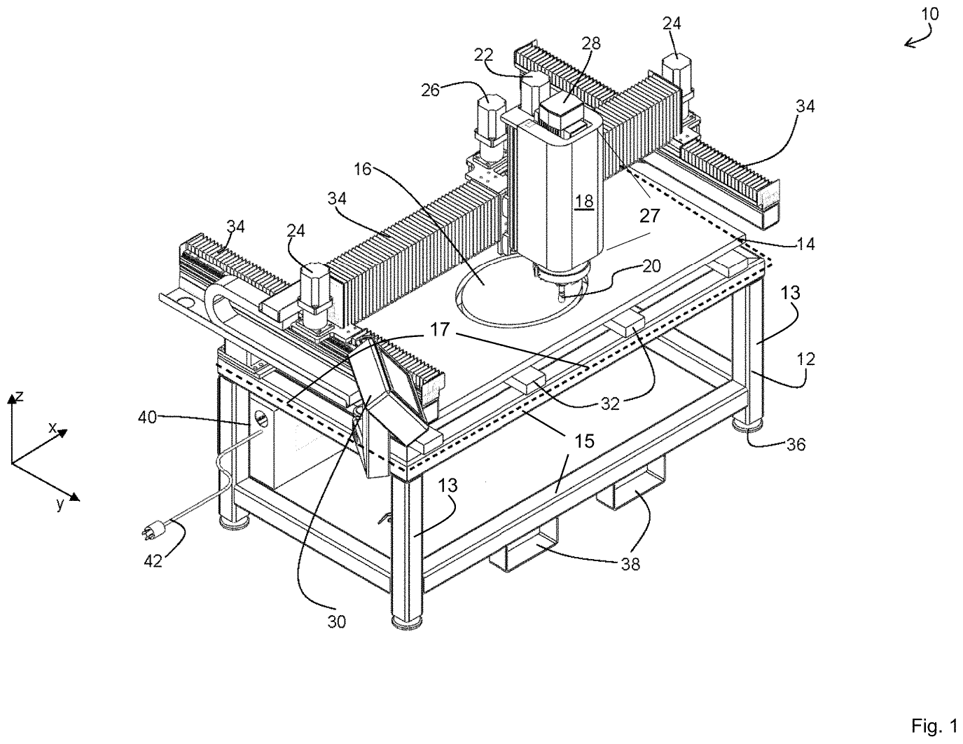

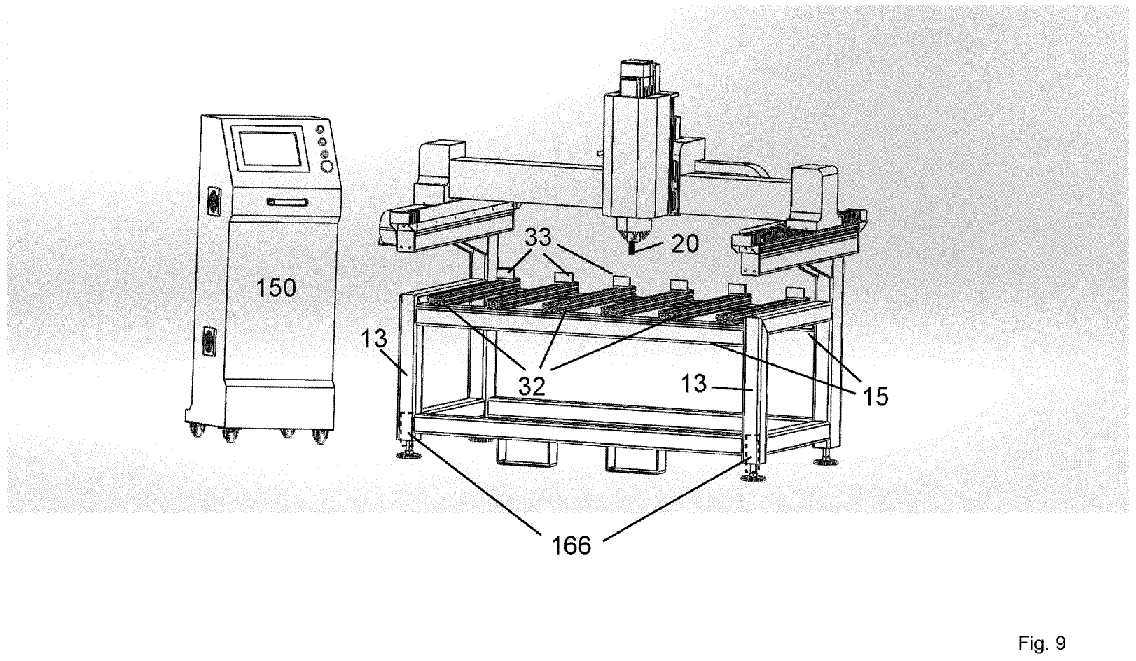

Turning to FIG. 1, depicted therein is a schematic overview of one embodiment of the invention. As shown in FIG. 1, the embodiment 10 includes a workbench base 12, depicted in the figure as a base for a table, the base comprising a plurality of vertical supports 13 joined by horizontally disposed elongated substrates 15 which provide side-to-side stabilization. Each of the vertical supports has a depending first end which contacts a ground surface such as a floor on which the system rests. Each of the vertical supports has an upwardly facing second end adapted to receive and support a plurality of the horizontally disposed substrates to define a rectangle, a square or other peripheral shape (partially shown as dashed lines 17) of a table top. However, the device is without a permanent countertop. Rather, the periphery so described herein is adapted to receive a first plurality of workpiece supports 32 spanning the width of the device. Each of the workpiece supports 32 is supported by the horizontally disposed substrates 15 such that the workpiece supports 32 may also be horizontally disposed. Further, each of the workpiece supports 32 has a first end proximal to the front of the device, and a second, distal end, with at least some of the distal ends terminating in a stop 33 (FIG. 9). The purpose of these stops are discussed infra.

As described in the attached figures, the components of the embodiment 10 are installed above the workbench base 12 and configured as a portable cantilever frame, the frame supported at the rear of the periphery, such that the remaining three of the sides of the periphery are open, allowing for ease of loading and unloading of a work piece regardless of its shape and length, that unloading occurring from the sides or front of the device. In other embodiments, not shown, the base comprises other shapes, such as an L-shape or a pair of sawhorses.

Attached to the base 12 is the workpiece, such as the countertop 14 shown in FIG. 1. The workpiece is removably attached to the base 12, by use of a clamp, removable fasteners, or the like (not shown). The components of the embodiment 10 create a cutout 16 from the workpiece, creating an aperture in the workpiece. In the embodiment shown in FIG. 1, the cutout 16 in the countertop 12 is a substantially round opening suitable for mounting of a sink.

The embodiment 10 uses a cutting assembly 18 to house various components necessary to accomplish the cutting tasks. A cutting bit 20 is extended from the cutting assembly 18 surface closest to the workpiece. The distance that the cutting bit 20 is extended is subject to control by the system. A cutting bit position motor 22 controls the depth of the cutting bit, in one embodiment.

This position motor 22 also varies the position of the bit along the bit's longitudinal axis. For example, during cutting, the bit is extended and retracted along its longitudinal axis (i.e., the z-axis of the system and in the case of countertops, the z-axis of the workpiece). This confers wear to the bit along its entire longitudinally extending surface, and not just at a single contact point, which is often the case in state of the art systems, as discussed supra. Generally, the oscillating or extension and retraction of the bit along its longitudinal axis is a method achieved by software not an ability of the hardware.

The cutting assembly 18 position in the x-y plane is controlled by the x-axis movement motor 26 and the y-axis movement motors 24. The three motors combined with other structural components of the device allow the cutting assembly 18 to reach any position within a precision of within about 1 mm. Several commercially available motors enable precisions of 0.1 mm or less.

The cutting bit 20 operates as a rotational cutting bit and its rotation is controlled by the cutting bit rotation motor 28.

The time of operation and the speed of operation of each motor 22, 24, 26, 28 is governed by the control unit 30. The control unit 30 will position the cutting assembly 18 as required and either lower or raise the cutting bit 20 to create the required cutout 16. The control unit 30 and power control unit 40 may be combined into a stand alone power and control console.

The workpiece such as the countertop 14 rests on multiple cross bar supports 32 in one embodiment. These cross bar supports ensure that the workpiece does not bend or crack while the cutout 16 is completed.

The cutting assembly 18 moves along rails protected by dust covers 34. The embodiment depicted in FIG. 1 includes a pair of linear guide rails (not visible due to the dust covers) which are mounted on both arms of the cantilever frame base 12. A beam (also obscured by the covers) moves along the guide rails driven by two stepper motors 24 at either or both ends of the beam. In one embodiment, this movement is accomplished by a rack and pinion mechanism. This allows the beam to move to any position in the y-coordinate plane, with the limits of the movement being defined by the rails. In turn, a set of three linear guide rails are mounted on the beam. A cartridge 27 moves along the guide rails driven by the motor 26, allowing the cartridge to be moved to any position in the x-coordinate within the operating range. The cartridge moves along the guide rails using a rack and pinion mechanism, in one embodiment. The x and y directions are shown in FIG. 1. The dust covers ensure that the dust created by the cutting action does not foul the movement motors thereby lowering the precision of the movement of the system. In addition, the cartridge may be adapted to be tilted at an angle to the x axis, the y-axis, the z-axis or all three simultaneously to effect beveled cuts. This adaptation may take the form of a step motor positioned relative to the x-axis, y-axis, and/or z-axis position step motors.

Movement of the assembly 18 in the vertical direction is accomplished by a pair of linear guide rails, which are mounted on the cartridge vertically. The movement of the assembly 18 up and down is driven by the stepper motor 22 mounted on the cutting assembly 18. In one embodiment, the movement occurs via a set of ball screw assembly, allowing the cutting assembly 18 to be moved (up and down) to any depth in the z-coordinate within the operating range. A fourth stepper motor may be employed to provide beveled edges to the work piece whereby the bit is positioned at an angle off of the z-axis or vertical. Alternatively, the bed of the system may be tilted off vertical to induce the formation of such bevels and/or facilitate loading the workpiece vertically.

The base 12 includes independently adjustable height supports 36, such as legs whose extension can be changed to ensure that the base 12 is substantially level. However, inasmuch as the legs are independently adjustable, legs at one end of the machine may be left longer or shorter than at the other end.

The base 12 also includes moving brackets 38, which allow the embodiment 10 to be moved to several worksites by the use of a forklift or jack. The brackets shown in FIG. 1 are configured as fixed rectangular stirrups adapted to receive forks from a forklift such that the stirrups maybe welded, removably attached via nut and bolt, or integrally molded with the system structure. Alternatively, the stirrups maybe independently and removably positioned relative to each other to adjust for various means for moving the entire assembly.

The various components of the embodiment 10 are provided power by a power and control unit 40. The power and control unit 40 includes an external power connection 42. In the embodiment shown, the external power connection is a standard plug as the system is portable and does not require permanent wiring nor does it require excessive current. In various embodiments, the system is powered by 120/208V (three phase) 20 A or 277/480V (three phase) 10 A.

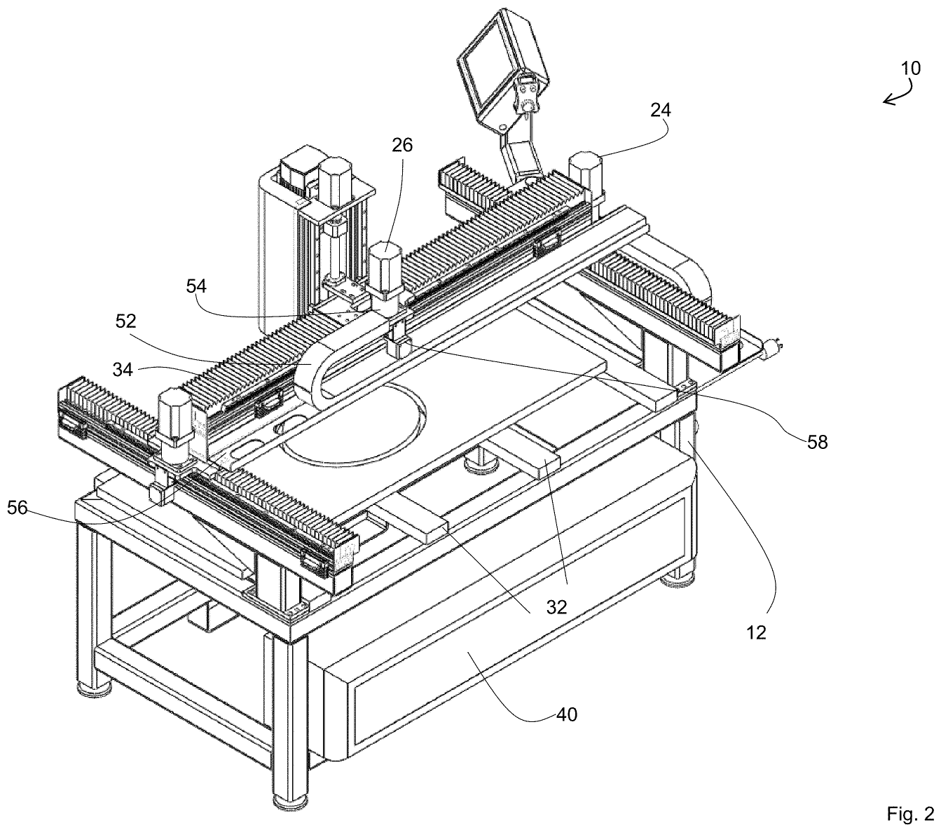

Turning to the view of one embodiment 10 in FIG. 2, visible therein are the cable and water tube carrier 52 which is attached to the cutting assembly at the attachment point 54. In one embodiment, the cable carrier as depicted in FIG. 2, houses cables and water conduits that are connected to move along with the motors and the cutting tool. The cable carrier, in one embodiment, is made of plastic or metal providing a cross-sectional rigid structure to contain and protect the cables and tubes while is radially flexible to allow the cables and tubes to move along.

As visible in FIG. 2, in one embodiment the cutting assembly includes the position sensor 58, however not all embodiments include this sensor.

Similarly, cable carriers are used in conjunction with one of the y-axis movement motors 24. This allows the movement of both the x-axis motor and the y-axis motors to be subject to precision control.

FIG. 2 also shows the power and control unit 40. In the embodiment shown in FIG. 2, the power and control unit 40 extends the length of the workbench base 12. However, the control unit 40 may extend the width of the workbench base and rotatably mounted thereto to accommodate instances where the entire cutting system 10 is rotated to a vertical configuration.

Alternatively, and as depicted in FIG. 9, the control unit may be engineered as a separate, stand alone unit 150.

### Cutting Assembly Details

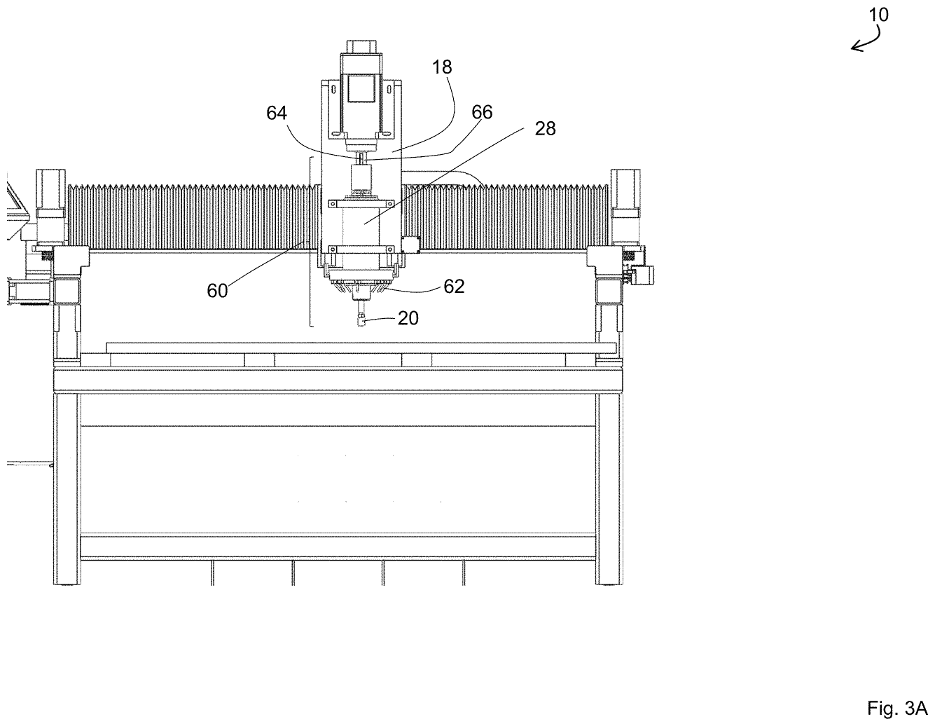

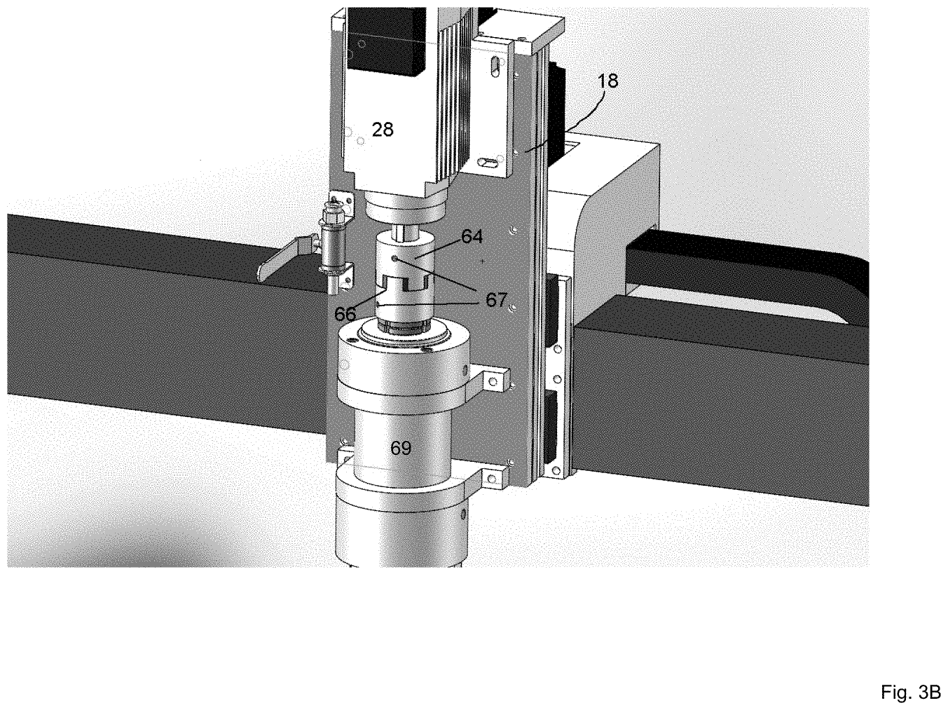

FIG. 3 depicts a front view of an embodiment 10 of the invention showing the details of the cutting assembly 18, with at least one cover of the cutting assembly 18 removed.

Shown in the detailed interior view is the spindle motor 28 and the cutting bit 20.

The cutting bit mechanical spindle 60 (driven by motor 28) includes the cutting bit 20 and nozzles 62 which provide cooling water used by the cutting process. Further provided are elements 64, 66, detailed in FIG. 3B, which couple the motor 28 and the spindle 69 together, in some embodiments. Elements 64 and 66 may couple to the shaft (element number??) in a typical keyway fashion, and reversibly fastened thereto by a plurality of keyway set screws 67.

### Power and Control Unit Details

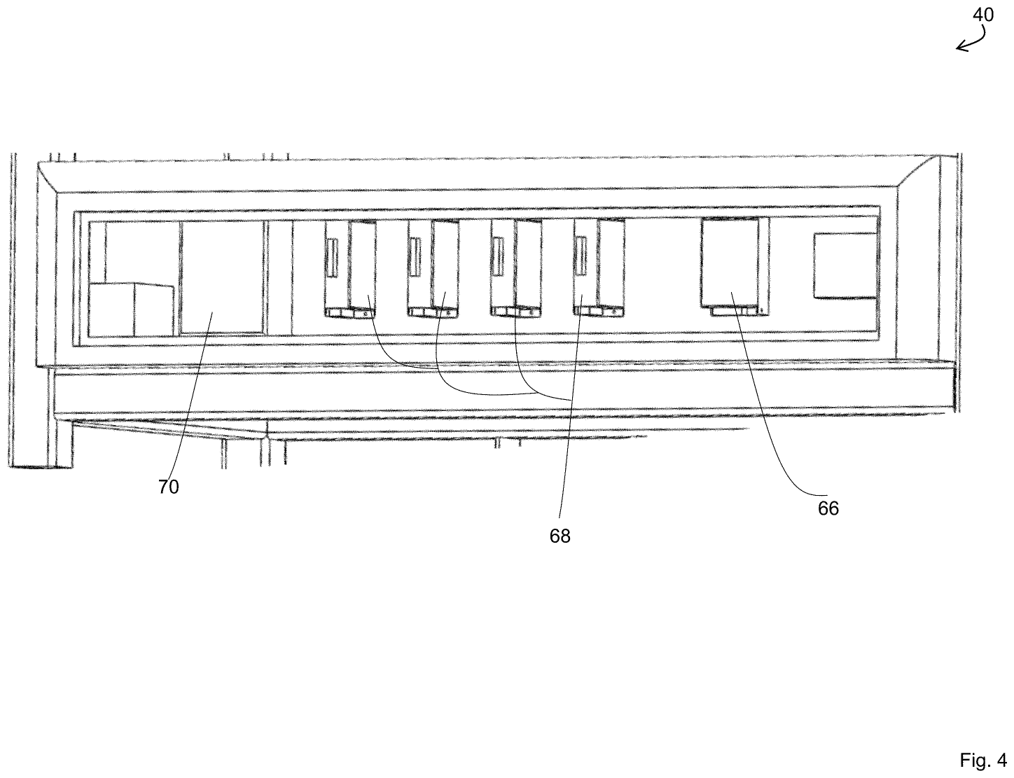

FIG. 4 depicts a detailed view of the power and control unit 40. The power and control unit 40 includes the power subunit 66 and motor control subunits 68. In one embodiment, each of the subunits is enclosed in a water-tight container to prevent the short circuiting of any of the subunits. The subunits 68 control each of the stepper motors, 22, 24, and 26. The control unit 40 also includes the variable frequency drive 70 for the motor 28.

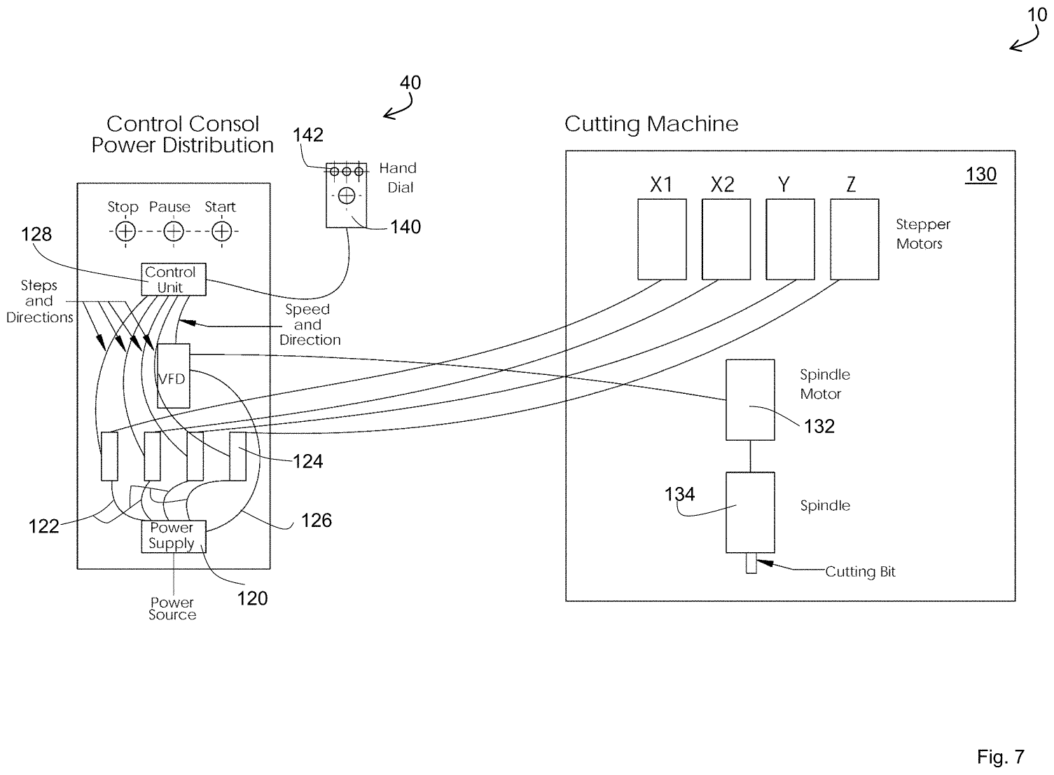

FIG. 7 depicts a detailed schematic of the components of the power and control unit 40 along with the interactions of the power and control unit 40 with the remaining components of an embodiment of the system 10.

The power control unit 40 includes two kinds of power supplies or one power supply with multiple subcomponents, in one embodiment. One set of power systems is the transformer for the four step motors described above, each of the step motors is connected by a driver. These motors are generally low voltage and consume low amounts of power. A second part of the power supply provides power to the main spindle motor 28 in the cutting assembly 18. In one embodiment, the motor 28 is a high power motor, which uses 3.7 kW of power. This high power motor turns the cutting bit, which contacts the substrate to be cut.

As shown in the schematic of FIG. 7, the power supply 120 provides at least two types of voltage and current sources. A first type 122 provides the power to the four stepper motor drives 124 that in turn feed the four stepper motors x1, x2, y and z in the cutting machine 130. A second type 126 of voltage and current source powers the VFD (variable frequency drive) that in turn feeds the spindle motor 132 that runs the cutting tool 134.

The control unit 128 sends commands to the four stepper motor drives that in turn operate the four stepper motors. The control unit 128 commands are in the form of positive and negative voltages, in one embodiment, those commands defined by G-code which is a commonly used type of CNC machine language. The end result of the commands is that the motors move in the required directions and desired distance of steps, so that the cutting tool of the cutting assembly is moved to the correct x-, y- and z-coordinate along the cutting route at programmed depths. The control unit 128 sends analogous commands to the VFD that in turn operates the spindle motor 132 in the desired direction and at a proper speed, as dictated by the present state of the system.

FIG. 7 also shows a hand dial 140. The hand dial 140 is in electrical communications with the controller 128. In one embodiment, the hand dial 140 allows for movement of the cutting assembly in all three coordinates. Other options on the hand dial include a simulation of the cutting route, the ability to start, stop, pause and emergency stop the process. The options on the hand dial are executed using a series of push buttons 142, in one embodiment. In another embodiment, the hand dial includes a touchpad interface with a variable display.

In FIG. 7, the various components are shown as having physical or wired connections. In some embodiments, several of the connections are implemented using wireless interfaces. For example, in some embodiments, the hand dial 140 includes a wireless interface with a wireless receiver in communications with the controller 128. Further, while each communication line is depicted a single line in the schematic in FIG. 7, in some embodiments, a single communications channel handles multiple types of messages, decreasing the number of required physical wires. As shown in the figure, the single lines show relationships between the components. In some embodiments, each line is implemented using a particular circuit or sets of circuits.

### Method of Use

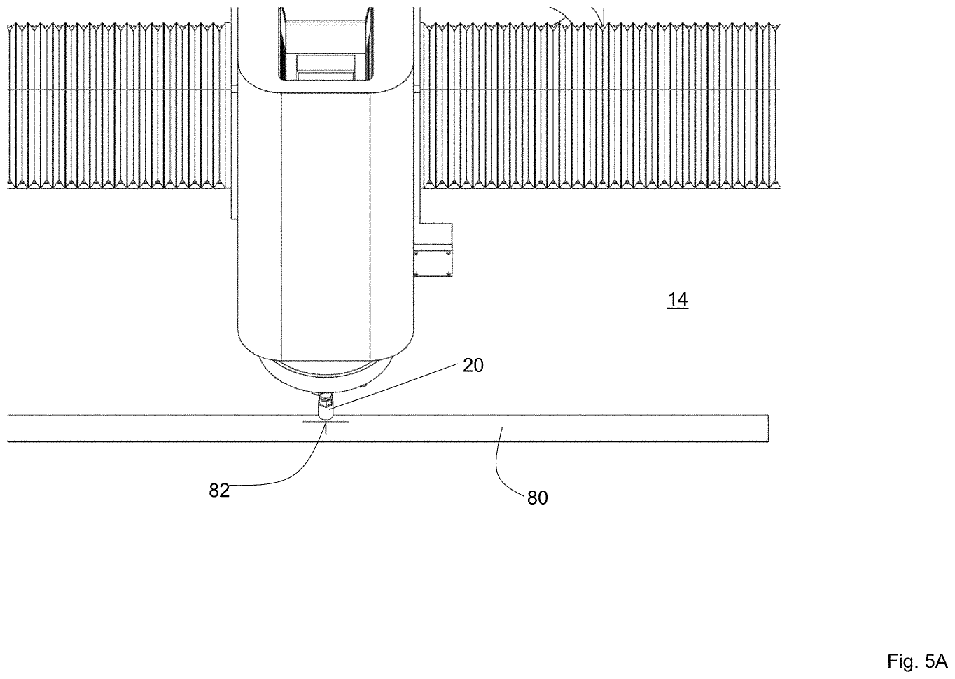

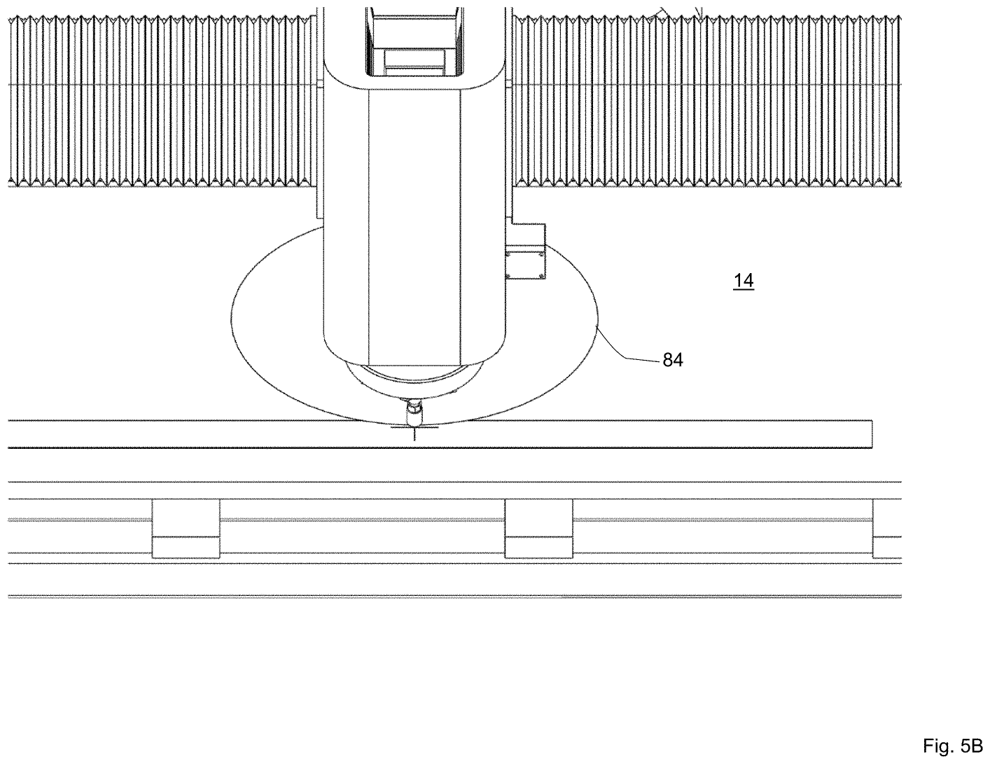

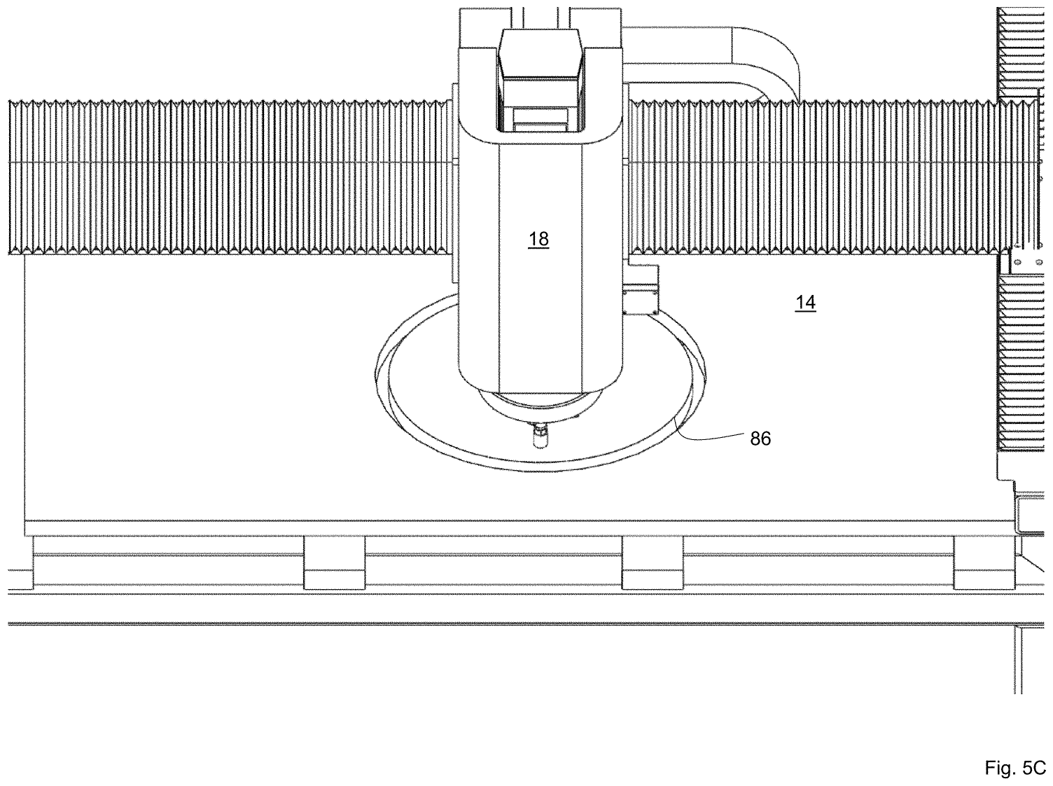

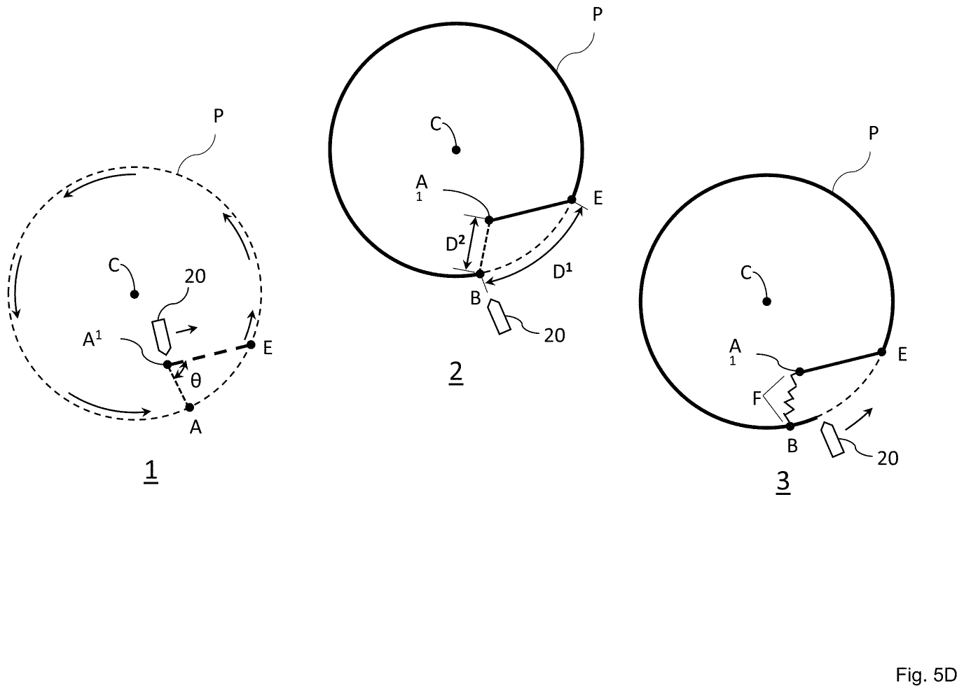

Several steps of the use of the system is shown in FIGS. 5A-C. In operation, a countertop workpiece 14 initially is placed on the workbench (not shown in FIG. 5A). A piece of tape 80 with a beginning mark 82 is added to the countertop. In one embodiment of the invention, the tape is added before the countertop is slid into place. In another embodiment, a removable mark is used in place of the tape, resulting in a mark on the work piece. The cutting bit 20 is moved into position over the starting mark 82. Therefore, the cutting tool is aligned with the mark and this location is set as the work piece coordinate origin, in one embodiment. There may be one work piece coordinate origin, or a plurality of origins, depending on the complexity of the cut out and whether the work piece needs to be repositioned after further processing elsewhere. Generally, since countertop cutouts are relatively simple in the realm of CNC machining, one origin may be sufficient.

The end user thereafter selects the template from the interface. In one embodiment, the template comprises a digital template in the form of a DXF file, or another industry standard file format. The end user may select the reference point in the digital template file which is aligned to the starting mark 82. The end user confirms the thickness of the workpiece 14 and the diameter and length of the cutting bit 20. The end user also selects the mounting style. While any value can be inputted, three sink mounting styles are most popular: 0−flush; positive value multitude of 1/16″—reveal; negative value multitude of 1/16″—overhang. The process is then confirmed and ready to start, in one embodiment.

As shown in FIG. 5B, prior to spinning up, the cutting assembly 18 traces a simulated path of the cutting, shown as imaginary line 84.

The cutting bit 20 then spins up, and cuts the actual groove 86 (FIG. 5C) in the workpiece 14. This is done by continuously repositioning the cutting assembly 18 relative to the stationary workpiece. In instances of generating a cutout in a countertop, the path cut is nearly an inch wide.

Surprisingly and unexpectedly, the inventors found that toward the end of the cutting sequence, for example, during the completion of a circular aperture, breakaway artifacts can be minimized so that chips to the final periphery of the aperture are avoided. The controller is programmed to start cutting at a point A¹, which is positioned medially from the periphery (dotted line P) defining the cutout. Cutting commences along a lead in line A1-E extending at an angle A-A¹-E which opens toward the periphery. (A “lead in line” indicates that the line leads into the periphery path from a point laterally located relative to the path.) Point A lies on the periphery P and point A1 is collinear with point A and the center C of the cutout. That angle θ is selected greater than 0 degrees and less than 90 degrees, preferably greater than 20 degrees and less than 80 degrees and most preferably between 45 and 75 degrees. Alternatively, a lead-in arc (instead of the afore-described lead in line) may be utilized such that an end of the arc line is tangent to the periphery P at point E.

As the cutting tool advances around the predetermined periphery P, it will reach a point B on the periphery, which is proximal to point A, so depicted in FIG. 5D2. The periphery region defined by an arc B-E remains uncut and has a first linear length dimension D¹. A second linear length dimension D2 is defined by line B-A1 such that D2 is less than D1.

That D1 is longer than D2 prompts the cutaway portion of the workpiece to fracture F along line B-A1 instead of B-E. This fracturing may occur prior to or during final cut stages where the bit 20 advances from point B to point E along the periphery, as depicted in FIG. 5D3.

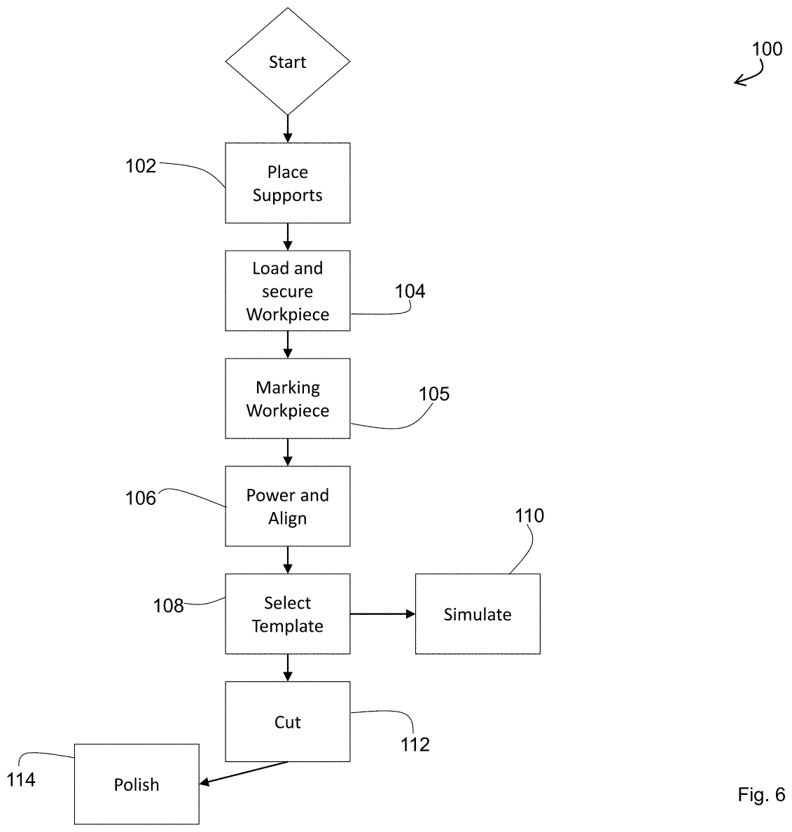

The process then moves to the polishing steps 114 (FIG. 6). In one embodiment, the process uses two polishing steps, once the opening 86 is cut. First, the cutting tool is replaced with a polishing tool. In one embodiment, the system instructs the operator as to which polishing tool should be used, depending on the type of material used in the countertop and the feedback received by the system from the cutting process. For example if the feedback reveals that any binding of the cutting bit occurred, resulting in rough spots along the cut, the system may prompt the human user to swap out a course polishing bit for the first polishing step. The cutting assembly with the polishing tool then repositions and starts the process.

Alternatively, the system used may be non-feedback. In implementing the polishing capacity, the two steps will be arbitrarily determined to use polishing tools of certain fineness. It may be necessary to reselect one or two polishing codes for the steps before starting polishing. Profiling tools can also be used, in a similar way as polishing tools, to create different edge profiles of the sink opening, possibly necessary by using separate profiling code.

As discussed supra, a fourth dimension of control may be added. In this dimension, the cutting assembly may tilt at an angle to achieve a desired beveled edge. This tilting function may be affected by hydraulic lifts 166, as depicted in FIG. 9. The lifts 166 may be positioned proximal to the distal ends of the vertical substrates 13, or else nested within the cavities defined by those distal ends in instances where the vertical substrates are hollow. Alternatively, the x-axis, y-axis, and/or z-axis motors may be modified to allow tilting along their respective lines of travel, as discussed supra.

Once at least one pass of the polishing tool is completed, the system moves to the second polishing step. The end user is prompted to replace the first polishing tool with a second polishing tool, in one embodiment. The cutting assembly then performs the second type of polishing on the cut surface of the workpiece 14.

The details of the process of use is shown in the flowchart of FIG. 6.

The cutting process 100 begins by placing supports 102 on the frame. In one embodiment the supports comprise several two-by-fours 32 (FIG. 5c, 8) or other dimensional lumber of sacrificial wood. These may be reused between countertops. The supports are placed at appropriate intervals to prevent the countertop from sagging while it is placed on the device.

Next, the countertop is loaded 104 on the device. As the device is an open workbench, the countertop can be inserted in any direction, from being slid into place, to being pivoted, or other direction, as necessitated by the available space at the particular location. As part of the loading step, the end user must ensure that the front edge of the countertop is parallel to the front of the workbench and that the desired sink opening is within reach of the cutting assembly's freedom of motion (as dictated by the guide rails). Alternatively, stops 160 (FIG. 9) may be provided so that the human operator need not worry about aligning the workpiece relative to the cutting bit 20 or the entire device. Rather, these preset stops aid in aligning the workpiece with the workbench.

FIG. 9 further features a plurality of work piece support structures 162 which extend from the front to the back of the device and are depicted as running the width of the device. Those structures 162 may in turn be supported by longitudinally extending substrates 164 positioned at either end of the support structures.

It should be appreciated that while the loading of the workpiece is shown along a horizontal plane, the workpiece may be loaded vertically and resting on one of its edges, such that the system is rotated 90 degrees. Appropriate workpiece supports would be utilized in those instances where the workpiece is supported on one of its edges.

Alternatively, hydraulic units 166 may be implemented at various vertical supports 13 of the system.

Next, the end user adds masking tape 105 to the top of the countertop along with the start target. The target comprises one line that is parallel to the front edge of the countertop and is the distance from the sink opening to the front edge. The second part of the target is a second line that perpendicularly intersects the first line which will be the point at which the center of the leading edge of the sink will be cut.

Thereafter, the user powers on the machine 106 and aligns the cutting assembly to the target drawn on the tape. In one embodiment the alignment is affected manually and perhaps even simplified with the utilization of removably replaceable stops along the periphery of the support surface of the workpiece. In another embodiment, the cutting assembly includes a camera which allows for automatic alignment. A myriad of positions are envisioned, and limited only by the configuration of the workpiece and the cutout shape. For example, when producing a cutout on a countertop or vanity the bottom of the bit may be between 1/16″ to ⅛″ above the countertop surface, with the cross section of the bit equally bisected by the perpendicular line and the parallel line of the marking. Once the bit is aligned, the end user sets the work piece coordinate origin by pressing a sequence of keys on the control panel.

CNC code is provided corresponding to each sink model. The operator selects a model from the controller console. The system will then cut according to the code (and other parameters such as the thickness of the countertop, the diameter and cutting length of the cutting bit and the amount of offset from the cutting route desired for larger or smaller opening than dictated by the standard code). The end user selects the digital template 108 and other settings from the control panel. One important feature is that offset to the standard cutting route can be achieved by inputting a number (positive or negative) from the controller console so that the opening is cut larger or smaller than the standard route.

In one embodiment, the end user selects a cutting template relevant to the brand and model of sink as well as designating the thickness of countertop (e.g., 1/16″ increments) and mounting style compensation (e.g., 1/16″ increments, default value 0 for FLUSH, positive number for REVEAL, and negative number for OVERHANG). In this embodiment, on the control unit the end user selects a sink model by a description or model number and the control unit reads sink opening template in G-code format. Finally in one embodiment, the end user sets the cutting bit size (with default being 0.866 inches in diameter and 1.5 inches in length”). In one embodiment, a number of the settings is automatic, depending on the part number of the sink and cutting tool. In one embodiment, the control unit calculates and generates G-code according to cutting route (the DXF file), input data for the thickness of the work piece and the mounting style, and other factors such as the tool size and an optimal angle of spiral tool feed.

Optionally, after loading the template, the end user can simulate 110 the cutting steps to ensure that the correct template and settings have been chosen. In one embodiment, the end user simulates the cutting by using a hand dial to simulate the cutting route and verify if it is aligned with a paper template. In another embodiment, the cutting assembly enters a special simulation mode and will show how the drill bit intends to follow the path of cutting on the countertop.

Thereafter, the end user begins the cutting steps 112. In one embodiment, the cutting steps begin by first applying cooling water to the workpiece surface, for example, actuating a valve to a conduit charged with cooling water. The start button is pressed. After the end user initiates the process, such as by pressing the start button, the cutting tool spins at desired speed and in required direction, the cutting tool moves to starting position (x-, y- and z-coordinates). The cutting tool starts to cut along the adjusted route as calculated by the control unit until the complete route is cut and the cutting tool rests at a designated point for easy loading and unloading of countertops. For example, cutting may begin with a programmed angle of spiral tool feed. The cutting continues (for multiple rounds) until the entire thickness of the work piece being cut through and the cutting tool rests at machine coordinate origin.

Following a cutting of the opening, the system proceeds to polishing steps 114. To perform the polishing steps 114, the end user changes the cutting bit into the first polishing tool and inputs the tool size. In one embodiment, the controller suggests the polishing tool to the end user. In one embodiment, the end user then presses the PREP button and the control unit calculates and generates G-code resulting in an adjusted polishing route. Once the route is configured in memory of the controller, the end user presses the START button and the control unit executes the G-code, so that the polishing tool spins at desired speed and in the right direction the polishing tool moves to starting position the polishing tool starts to polish along the adjusted route for one or more rounds as programmed. Once the polishing tool is done with polishing, the polishing tool rests at machine coordinate origin. The system then prompts the end user to change of tool to polishing tool number two and input tool size. The polishing process is then repeated for the secondary polishing tool.

Once cutting and polishing is complete, the end user will shut off the cooling water valve, press the “Return” button to return the cutting assembly to a docking position, and will turn off the power before removing the countertop.

While the steps above are shown as consecutive for purposes of clarity, several of these steps may occur in different order or be accomplished concurrently. For example, the ‘add tape 105’ step can be done ahead of time and not only after the countertop has been loaded unto the device.

While the steps above describe a system where the end user replaces the polishing tools and the cutting tool manually, in one embodiment the cutting assembly 18 includes multiple drill bits and polishing tools which are changed automatically. In this embodiment, the cutting and polishing steps of the process occur automatically.

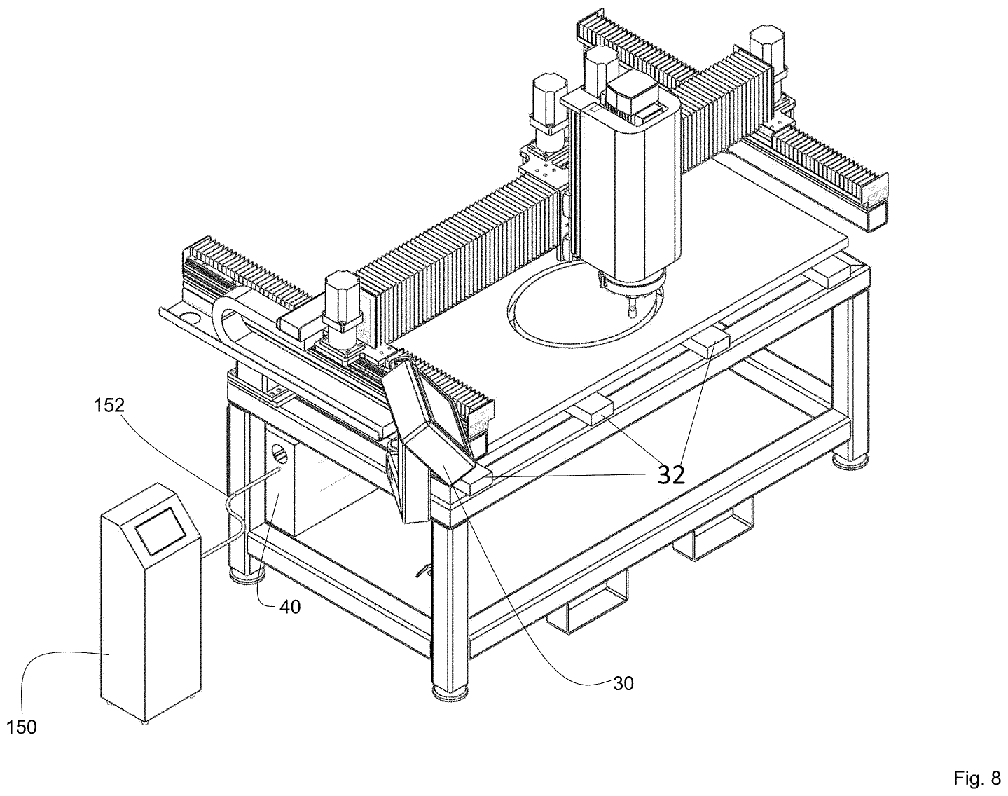

In an alternative embodiment shown in FIG. 8, the controller 30 and the power unit 40 are located in an external enclosure 150, which communicates with the device via a connection 152. A benefit of this embodiment is that the external enclosure 150 can communicate with multiple cutting workstations, decreasing costs per unit, and also provides a single place to replace components, in case of failure.

While not shown in the figures, in one embodiment, the water supplied to the system during cutting and/or polishing runs through waterproof channels through the cutting assembly 18 and cools the bearings and other mechanical components within the cutting assembly 18. The water then exits the channels via nozzles placed in proximity to the cutting or polishing area of the cutting assembly 18.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A device for cutting an opening in a workpiece comprising:
a base for receiving and securing the workpiece;
a cutting assembly comprising a rotating cutting tool and a servomotor for controlling a depth of the rotating cutting tool;
a set of guide rails attached to said base wherein said cutting assembly moves along said rails;
a position controller which controls the position of said cutting assembly by operating a first plurality of stepper motors for calculated periods of time and the depth of the rotating cutting tool by operating a second plurality of steppers motor for a set period of time; and
a power supply in communication with said cutting assembly and controller;
wherein said controller uses digital templates of sink openings to position the cutting assembly along the guide rails.

2. The device of claim 1 wherein each said servomotor is controlled by a controller which includes a voltage and a current sensor.

3. The device of claim 1 wherein said base is moveable.

4. The device of claim 1 wherein said controller controls current and voltage to each of said servomotor provided by the power supply.

5. The device of claim 1 wherein the first and second plurality of stepper motors are manipulated by G-codes corresponding to sink models.

6. The device of claim 5 wherein the G-codes utilize input parameters defining the workpiece mounting styles.

7. The device of claim 1 wherein the base is configured to support the workpiece in a horizontal position relative to a longitudinal axis of the workpiece.

8. The device of claim 1 wherein the base is configured to support the workpiece in a vertical position relative to a longitudinal axis of the workpiece.

9. A method for cutting an aperture in a workpiece, the method comprising;
a) supporting the workpiece;
b) using G-code to direct a cutting bit to form the aperture in the workpiece.

10. The method as recited in claim 9 wherein the workpiece has a longitudinal axis and the workpiece is supported perpendicular to its longitudinal axis.

11. The method as recited in claim 9. wherein the workpiece has a longitudinal axis and the workpiece is supported parallel to its longitudinal axis.

12. The method as recited in claim 9 wherein the step of forming the aperture further comprises
c) begin contacting the cutting bit on a starting point of the workpiece that is located medially from a periphery of the workpiece;
d) advancing the cutting bit from the starting point and in a radial direction to a first point on the periphery;
e) advancing the cutting bit along the periphery to a second point on the periphery, wherein the second point is located a first distance D1 from the first point on the periphery and a second distance D2 from the starting point of the workpiece such that D1 is greater than D2; and
f) advancing the cutting bit from the second point of the periphery a second distance d2 to the starting point of the periphery;

13. The method as recited in claim 12 wherein the workpiece fractures along a line defined by the starting point on the workpiece and the second point of the periphery.

14. The method as recited in claim 13 wherein the fracture occurs during advancing of the cutting bit from the second point of the periphery to the first point of the periphery.

15. The method as recited in claim 9 wherein the cutting bit is extended and retracted in an axial direction while it cuts through the workpiece.

16. The method as recited in claim 9 wherein the step of using G code occurs without first creating CNC machine code.

17. The method as recited in claim 9 wherein the workpiece is a countertop.
